(19) United States
(12) Patent Application Publication
(10) Pub. No.: US 2024/0128431 A1
(43) Pub. Date: Apr. 18, 2024

(54) RECHARGEABLE BATTERY AND METHOD FOR PRODUCING A RECHARGEABLE BATTERY

(71) Applicant: Volkswagen Aktiengesellschaft, Wolfsburg (DE)

(72) Inventors: Miriam Kunze, Seelze (DE); Tobias Jansen, Braunschweig (DE); Stephan Leonhard Koch, Salzgitter (DE)

(21) Appl. No.: 18/488,553

(22) Filed: Oct. 17, 2023

(30) Foreign Application Priority Data
Oct. 17, 2022 (DE) 102022210958.9

(51) Int. Cl. H01M 4/04; H01M 10/0525; H01M 10/0562

(52) U.S. Cl. CPC H01M 4/0407; H01M 10/0525; H01M 10/0562; H01M 2004/027

(57) ABSTRACT

Technologies and techniques for producing a rechargeable battery that includes at least one lithium-ion cell in which a negative electrode, a positive electrode and a solid electrolyte are arranged. An electrolyte suspension including an electrolyte material being mixed for the creation of the solid electrolyte, a green sheet being created with the electrolyte suspension, and a protective layer, which includes a base element for a lithium alloy, being applied onto the green sheet.

### RELATED APPLICATIONS

The present application claims priority to German Pat. App. No. DE 10 2022 210 958.9 filed Oct. 17, 2022, to Kunze, et al., the contents of which is incorporated by reference in its entirety herein.

### TECHNICAL FIELD

The present disclosure relates to technologies and techniques for producing a rechargeable battery, which include at least one lithium-ion cell in which a negative electrode, a positive electrode, and a solid electrolyte are arranged. Moreover, the present disclosure relates to a corresponding rechargeable battery.

### BACKGROUND

Lithium-ion rechargeable batteries are widely used as stores of electrical energy. They are also used in the automotive field, amongst others, where they are used in particular as so-called drive or traction batteries for driving hybrid or electric vehicles.

Lithium-ion rechargeable batteries, comprising a liquid electrolyte are particularly in high levels of use. Furthermore, batteries comprising a solid electrolyte are also known. Such a solid electrolyte, also referred to as a solid-state electrolyte, is formed by a lithium ion-conducting ceramic, for example, which is produced in a sintering process.

The disadvantage with such solid-state electrolytes is that these exhibit instability toward air moisture and toward atmospheric oxygen, so that the production of corresponding lithium-ion rechargeable batteries must at least intermittently be carried out in a protective atmosphere. In addition, a considerable portion of the lithium disadvantageously evaporates from the material within the scope of the sintering process, whereby the lithium conductivity is decreased.

### SUMMARY

Aspects of the present disclosure are directed to producing a rechargeable battery that avoids at least some of these drawbacks. Some aspects are disclosed in the features recited in the independent claims. Advantageous embodiments including expedient refinements of some aspects are described in the dependent claims.

In some examples, a method is disclosed for producing a rechargeable battery that is configured as a lithium-ion rechargeable battery. The rechargeable battery comprises at least one lithium-ion cell. For a multitude of applications, however, a corresponding rechargeable battery comprises multiple lithium-ion cells, wherein the lithium-ion cells typically have a substantially identical design. In some examples, the rechargeable battery may be configured as a so-called drive or traction battery for driving a hybrid vehicle or an electric vehicle.

In some examples, a corresponding lithium-ion cell (hereafter also referred to as “cell” for short) is disclosed, comprising a negative electrode, a positive electrode and a solid electrolyte, also referred to as a solid-state electrolyte. The lithium-ion rechargeable battery is thus designed as a lithium-ion solid-state rechargeable battery. Depending on the application case, the lithium-ion solid-state rechargeable battery may be configured as a so-called thin-film rechargeable battery or thin-film battery.

The advantages and refinements described in connection with the method are to be applied, mutatis mutandis, to the rechargeable battery, and vice versa.

### DESCRIPTION OF THE DRAWINGS

Further advantages, features and details of the invention will be apparent from the claims, the following description of preferred embodiments and based on the schematic drawings. In the drawings:

FIG. 1 illustrates a simplified side view of a rechargeable battery comprising multiple lithium-ion cells, according to some aspects of the present disclosure;

FIG. 2 illustrates a simplified sectional view of a lithium-ion cell, according to some aspects of the present disclosure;

FIG. 3 illustrates a simplified side view of a first manufacturing line for producing a component for the lithium-ion cell, according to some aspects of the present disclosure; and

FIG. 4 illustrates a simplified side view of a second manufacturing line for producing the component for the lithium-ion cell, according to some aspects of the present disclosure.

### DETAILED DESCRIPTION

Like parts in the present disclosure are denoted by like reference numerals in all the figures.

The technologies and techniques described herein are directed to producing a lithium-ion cell, and thus also to produce a rechargeable battery. So as to create the solid electrolyte, an electrolyte suspension is mixed, which comprises an electrolyte material and typically additionally a binder and/or a solvent.

In principle, any known (solid-state) electrolyte material may be used as the electrolyte material. Typically, a material is used that is considered to be an oxide electrolyte, sulfide electrolyte, nitride electrolyte or halide electrolyte. Preferably, however, a material is used which has a so-called LISICON structure (LISICON: lithium super ionic conductor), a NASICON structure (NASICON: sodium super ionic conductor), a garnet structure, a perovskite structure or an anti-perovskite structure. Useful electrolyte materials having a LISICON structure typically have the chemical formula Li₂₊₂ₓZn₁₋ₓGeO₄. Examples of materials having a NASICON structure are lithium aluminum titanium phosphates, that is, materials having the chemical formula Li₁₊ₓAlₓTi₂ₓ(PO₄)₃, or lithium aluminum germanium phosphates, that is, materials having the chemical formula Li₁₊ₓAlₓGe₂ₓ(PO₄)₃. Useful electrolyte materials having a garnet structure are, for example, lithium lanthanum zirconium oxide, that is, materials having the chemical formula Li₇La₃Zr₂O₁₂, lithium lanthanum zirconium aluminate, and lithium lanthanum zirconium tantalate, and a suitable electrolyte material perovskite structure is lithium lanthanum titanate.

Depending on the application, polyninyl butyral can be used as a binder. Organic solvents are usually expediently used as solvents. Preferably, an anhydrous solvent is used. In some instances, Oppanol is a suitable solvent, or isopropanol may be used.

Using the electrolyte suspension, which is also referred to as a slurry, a green body layer known as “green sheet” is then created, wherein the electrolyte suspension is applied for this purpose onto a film, for example, in particular a plastic film. The film is typically removed again prior to sintering and, depending on the application case, has a thickness or strength having a value in the range of 5 μm to 100 μm. The thickness of the green sheet preferably has a value in the range of 5 μm to 100 μm and in particular is in the range between 10 μm and 60 μm.

Furthermore, a protective layer is applied onto the green sheet. The protective layer is preferably applied directly, that is, straight, onto the green sheet, and accordingly no further layer is then present between the green sheet and the protective layer. The protective layer may include a base element for a lithium alloy. The base element is, for example, silicon, tin, arsenic, antimony or aluminum. Depending on the application case, the protective layer is applied so as to have a thickness or strength in the range of 0.5 μm to 50 μm, and in particular in the range of 1 μm to 40 μm.

The protective layer, which is typically applied onto an upper side of the green sheet, subsequently protects the green sheet, that is, at least the upper side of the green sheet, in particular against air moisture and atmospheric oxygen. This is advantageous for subsequent method steps.

After the protective layer has been applied, a drying process is carried out in some instances, during which the layering encompassing the green sheet and the protective layer is dried. Regardless of whether or not such a drying process is carried out, the green sheet is sintered during the course of the method, preferably together with the protective layer, so that the solid electrolyte is formed of the green sheet. This means that the aforementioned layering is subjected to a sintering process. If an aforementioned film is employed, onto which the green sheet is applied, this film is typically removed prior to sintering.

In some examples, the negative electrode is created or finished such that lithium is supplied to the base element of the protective layer, so that a lithium alloy is created, which thereafter serves as the negative electrode or anode. For this purpose, a type of formation process, also referred to as formation for short, is preferably utilized.

During the course of this formation process, lithium is conducted from the solid electrolyte by means of an electrical voltage to the protective layer, whereby the lithium alloy is created from the base element and the lithium. The formation process is typically carried out after the solid electrolyte has been arranged, together with the protective layer and the positive electrode, in a housing or in an encasement of the lithium-ion cell. Regardless of whether the formation process is carried out inside or outside such a housing or such an encasement, the positive electrode or cathode preferably serves as a lithium source for the solid electrolyte during the formation process. This means that lithium is, or more particularly lithium ions are supplied from the positive electrode into the solid electrolyte. The solid electrolyte is thus typically not depleted.

Depending on the application case, not only a lithium alloy is created during the course of the formation, but additionally also a lithium layer, namely between the lithium alloy and the solid electrolyte. In this case, the lithium layer and the lithium alloy then create a hybrid electrode, which thereafter serves as the negative electrode or anode. This process can typically be controlled by the amount of alloying material and/or by the duration of the formation. During the course of the process, first the lithium alloy is formed, and when the alloying material has essentially been consumed, the process continues with the deposition of the pure lithium metal. As an alternative or in addition, the process can usually also be controlled by way of the current intensity. The current intensity determines the speed of the deposition process. However, an excessively high current intensity is typically not desirable since this may cause strong relaxation effects, which then take place uncontrolled.

As mentioned previously, the protective layer may be applied onto the green sheet during the course of the method. One useful method variant is that in which a base element suspension is mixed for this purpose, which includes the base element, in this example. The base element is then typically present in the base element suspension in the form of particles. These particles, that is, the base element particles, expediently have an average size in the range of 50 nm to 10 μm, and in particular in the range of 200 nm to 5 μm. Apart from this, a binder and/or a solvent is generally part of the base element suspension, wherein usually the binders and solvents used are the same as in the case of the electrolyte suspension. This base element suspension is then applied onto the green sheet so as to create the protective layer, and more specifically in particular by way of a traditional coating method, that is, for example, by printing or spraying.

In some examples, a base element powder may be applied onto the green sheet so as to create the protective layer, or a film is applied, which includes the base element or is formed of the base element.

Regardless, the protective layer is preferably applied onto the upper side of the green sheet, as was already indicated above. In some instances, the application is carried out in such a way that the applied protective layer completely covers the upper side of the green sheet. According to an alternative embodiment, only a partial surface on the upper side is covered by the protective layer. So as to achieve such a partial coverage, a mask or an auxiliary frame, that is, a kind of template, is then placed onto the green sheet, for example, for applying the protective layer. Such a mask or such an auxiliary frame is produced, for example, from a plastic material or a metal, in particular stainless steel, and is usually removed again after the application. If an aforementioned base element suspension is applied, the viscosity of the base element suspension typically determines whether such a mask or such an auxiliary frame is used for implementing a partial coating.

Depending on the application case, the base element and the electrolyte material are selected in such a way that the base element has a melting point that is higher than the sintering temperature of the electrolyte material. In this way, for example, it is possible to reduce the risk that a reaction occurs between the base element and the electrolyte material. If the base element is additionally present in the base element suspension in the form of particles, this particle form is typically preserved until after the sintering process. In this way, it is also possible to create a porous structure by way of the base element.

As an alternative, the base element and the electrolyte material are selected in such a way that the base element has a melting point that is lower than the sintering temperature of the electrolyte material. In this case, the base element is then liquefied in the protective layer during the sintering process.

Moreover, method variants in which a so-called current collector is applied onto the protective layer, prior to sintering, may be advantageous. The current collector is typically a metal film, such as nickel, which is placed and/or pushed onto the protective layer. If an above-described drying process of the layering including the green sheet and the protective layer is provided for, the current collector is more preferably applied prior to drying. Regardless, such a current collector preferably has a strength or thickness having a value in the range of 4 μm to 20 μm.

In some examples, the current collector may be applied while dispensing with an additional binder. This means that in particular an adhesive substance, such as a glue, is dispensed with.

In some examples, a corresponding current collector may be applied after the sintering process. In this case as well, the current collector is typically formed by a metal film. However, usually a binder of the aforementioned type may be used in this case, so as to fix the current collector to the protective layer. Moreover, the metal film is then typically made of a metal, such as aluminum, having a considerably lower melting temperature than nickel.

As was already described above, the protective layer is typically applied onto the upper side of the green sheet, and the green sheet is subsequently sintered together with the protective layer, so that the solid electrolyte is created from the green sheet. Thereafter, the upper side of the solid electrolyte is then protected by the protective layer. In an advantageous refinement, an electrode suspension is then applied onto an underside of the solid electrolyte located opposite the upper side so as to create the positive electrode or cathode. For creating the positive electrode, an electrode suspension that comprises an electrode material is thus mixed, and this electrode suspension is then applied onto the solid electrolyte so as to create an electrode layer, which ultimately creates the positive electrode.

Depending on the application case, a lithium metal oxide, for example, is used as the electrode material for creating the positive electrode, such as lithium manganese oxide, or, for example, a lithium-nickel-manganese alloy is used. The electrode material is then typically present in the electrode suspension in the form of particles. These particles, that is, the electrode particles, expediently have an average size in the range of 2 μm (of primary particles) to 25 μm (of secondary particles) Apart from this, a binder, for example PVDF, and/or a solvent, for example N-methylpyrrolidone, are generally part of the electrode suspension. This electrode suspension is then applied onto the solid electrolyte so as to create the electrode layer, and more specifically in particular by way of a traditional coating method, that is, for example, by printing or spraying.

Regardless, the electrode layer is preferably applied onto the underside of the solid electrolyte, as was already indicated above. The application is preferably carried out in such a way that the applied electrode layer completely covers the underside of the solid electrolyte. According to an alternative embodiment, only a partial surface on the underside is covered by the electrode layer. So as to achieve such a partial coverage, an auxiliary frame, that is, a kind of template, is placed onto the solid electrolyte, for example, for the application of the electrode layer.

Moreover, the electrode suspension is preferably applied before the solid electrolyte has completely cooled down again after the sintering process. This means that, during the application of the electrode suspension, the solid electrolyte typically has a temperature having a value in the range of 50° C. to 150° C. Moreover, a drying process is preferably carried out after the electrode suspension has been applied, wherein in this case the finished positive electrode is formed from the electrode layer by drying.

After the electrode suspension has been applied or the electrode layer has been dried, as mentioned above, furthermore a current collector is typically applied onto the electrode layer or the finished positive electrode. This current collector is typically formed by a metal film. If electron collectors are applied in each case onto the protective layer and the electrode layer or finished positive electrode, the electrode collectors usually have the same design, that is, are in particular made of the same material.

Using the above-described method, a basic element is now preferably produced, which comprises the solid electrolyte that is coated with the protective layer on a first side and with the positive electrode on a second, opposing side. The solid electrolyte, the protective layer and the positive electrode are thus part of the basic element. Depending on the application case, this basic element additionally comprises one or two current collectors, that is, a current collector that is applied onto the protective layer and/or a current collector that is applied onto the positive electrode.

This basic element is typically introduced into a housing or an encasement so as to create the lithium-ion cell. Thereafter, the above-described formation, that is, the formation process, is then preferably carried out so as to create or finish the negative electrode.

In some application cases, the basic element is expanded prior to this step, that is, prior to the introduction into a housing or into an encasement, by attaching further layers of the aforementioned type and, if necessary, further current collectors to this basic element. In this way, a bipolar lithium-ion cell, for example, can be produced.

The above-described method offers a number of advantages. For example, the protective layer prevents the surface of the green sheet or of the solid electrolyte located beneath from coming in contact with atmospheric oxygen or air moisture. The same applies to the electrode layer or the finished positive electrode. In this way, the use of a protective atmosphere or an inert gas atmosphere can be dispensed with, at least in individual method steps, and such a use is then preferably in fact dispensed with.

Typically, the use of a protective atmosphere or an inert gas atmosphere is dispensed with at least in all method steps that follow the application of the protective layer, or at least in all method steps that follow the application of the electrode layer. As an alternative, the use of a protective atmosphere or an inert gas atmosphere is dispensed with at least in all method steps that follow the sintering process. More preferably, the use of a protective atmosphere or an inert gas atmosphere is dispensed during the execution of all method steps of the method, that is, in particular during the execution of all above-described method steps.

During the sintering process, the protective layer furthermore prevents lithium from being lost as a result of the evaporation described at the outset. The use of so-called protective plates during the sintering process can thus be dispensed with, and the use thereof is typically in fact dispensed with.

Since the created protective layer is not removed again, but essentially converted into the negative electrode during the course of the method, furthermore a uniform surface for the solid electrolyte is implemented, and additionally a homogeneous formation of the negative electrode on this surface is achieved. In this way, an additional surface treatment of the solid electrolyte, which is otherwise necessary, is eliminated.

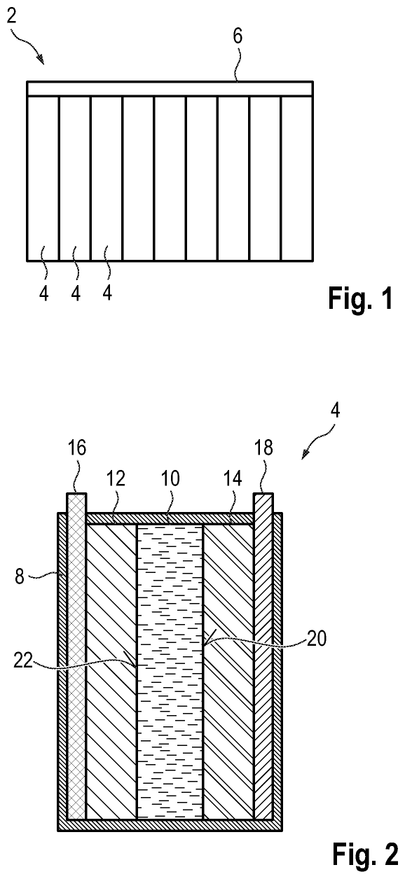

Turning to FIG. 1, the drawing illustrates an exemplary method for producing a rechargeable battery 2, which is configured in this example as a lithium-ion rechargeable battery 2. In many application cases, such a rechargeable battery 2 comprises multiple uniformly designed lithium-ion cells 4, or cells 4 for short. The corresponding cells 4 are then usually interconnected in the rechargeable battery 2 in a manner that is not shown in greater detail by way of an interconnection device 6.

In any case, however, such a rechargeable battery 2 may include at least one cell 4, and one possible embodiment of such a cell 4 is shown in FIG. 2 in a simplified sectional illustration. The cell 4 comprises a cell housing 8, in which a solid electrolyte 10, a positive electrode 12 and a negative electrode 14 are arranged. Moreover, the cell 4 comprises two current collectors 16, 18 that are formed of metal films, namely a current collector 16 that is fixed to the positive electrode 12 and a current collector 18 that is fixed to the negative electrode 14.

The solid electrolyte 10, the positive electrode 12 and the negative electrode 14 are furthermore created by a finished multi-layer structure made up of three mutually connected layers. The solid electrolyte 10 is then connected to the negative electrode 14 on a first side, hereafter referred to as the upper side 20, and to the positive electrode 12 on a second, opposing side, hereafter referred to as the underside 22.

In the exemplary embodiment, the finished multi-layer structure is produced from an unfinished multi-layer structure during the course of a formation process. This unfinished multi-layer structure is formed by the solid electrolyte 10, the positive electrode 12 and a protective layer 26, which adjoins the upper side 20 of the solid electrolyte 10. The unfinished multi-layer structure is initially prefabricated, and the current collectors 16, 18 are fixed to this unfinished multi-layer structure, that is, glued on, for example, by means of an adhesive. Thereafter, the unfinished multi-layer structure is introduced into the cell housing 8 together with the current collectors 16, 18, and the formation is carried out during a later method step.

During the course of this formation, lithium is conducted from the solid electrolyte 10 to the protective layer 26 by means of an electrical voltage that is applied to the current collectors 16, 18, whereby a lithium alloy is created from a base element in the protective layer 26 and the lithium. This lithium alloy thereafter acts as the negative electrode 14. In this way, the finished layering results from the unfinished layering in that the protective layer 26 is converted into the negative electrode 14.

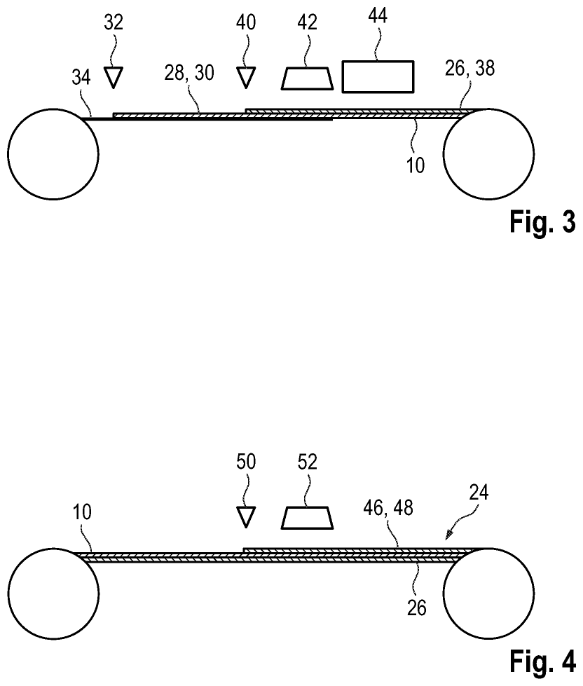

As was already mentioned above, the unfinished multi-layer structure is prefabricated. In the exemplary embodiment, the unfinished multi-layer structure is produced in such a way that first a material strip 24 is produced. This is indicated in FIG. 3 and FIG. 4. During the course of a severing process, which is not shown, the unfinished multi-layer structure is then cut out from the material strip 24.

So as to produce the material strip 24, initially an electrolyte suspension 28 is mixed, which comprises an electrolyte material, for example an electrolyte material having a garnet structure, that is, a material having the chemical formula Li₇La₃Zr₂O₁₂, or an electrolyte material having an NASICON structure, that is, a material having the chemical formula Li₁₊ₓAlₓTi₂ₓ(PO₄)₃. Using the electrolyte suspension 28, a green sheet 30 is then created by spraying the electrolyte suspension 28, for example by means of a first spray head 32, onto a film 34.

Furthermore, the protective layer 26 is applied onto the green sheet 30. For this purpose, initially a base element suspension 38 is mixed, which comprises the base element, such as silicon. Using the base element suspension 38, the protective layer 26 is then created by spraying the suspension, for example by means of a second spray head 40, onto the green sheet 30.

The protective layer, which is applied onto the upper side 20 of the green sheet 30, subsequently protects the green sheet 30, that is, at least the upper side 20 of the green sheet 30, in particular against air moisture and atmospheric oxygen.

After the protective layer 26 has been applied, a drying process is carried out in the exemplary embodiment, during which the layering encompassing the green sheet 30 and the protective layer 26 is dried. A radiant heater 42 is used for this purpose, for example.

In a further method step, the green sheet 30 is sintered together with the protective layer 26 so that the solid electrolyte 10 is formed from the green sheet 30. This means that the aforementioned layering is subjected to a sintering process. In the exemplary embodiment, the sintering process is carried out by means of a furnace 44, and the aforementioned film 34 that was applied onto the green sheet 30 is removed prior to sintering.

In the exemplary embodiment, the above-described method steps for producing the material strip 24 take place in a so-called roll-to-roll process, which is indicated in FIG. 3. For the method steps described hereafter, a further roll-to-roll process, which is outlined in FIG. 4, is then preferably used, during which the material strip 24 is finished.

During the course of the further roll-to-roll process, an electrode suspension 46 is applied onto the underside 22 of the solid electrolyte 10 for creating the positive electrode 12. For this purpose, an electrode suspension 46 is mixed, which comprises an electrode material, typically a lithium metal oxide, such as lithium manganese oxide. Using the electrode suspension 46, the electrode layer 48 is then created by spraying this suspension, for example by means of a third spray head 40, onto the underside 22 of the solid electrolyte 10.

In the exemplary embodiment, a drying process is carried out after the electrode layer 48 has been applied, during which the electrode layer 48 is dried. A radiant heater 52 is used for this purpose, for example.

List of Reference Numerals

| | |
|---|---|
| 2 | rechargeable battery |
| 4 | lithium-ion cell |
| 6 | interconnection device |
| 8 | cell housing |
| 10 | electrolyte |
| 12 | positive electrode |
| 14 | negative electrode |
| 16 | current collector |
| 18 | current collector |
| 20 | upper side |
| 22 | underside |
| 24 | material strip |
| 26 | protective layer |
| 28 | electrolyte suspension |
| 30 | green sheet |
| 32 | first spray head |
| 34 | film |
| 38 | base element suspension |
| 40 | second spray head |
| 42 | radiant heater |
| 44 | furnace |
| 46 | electrode suspension |
| 48 | electrode layer |
| 50 | third spray head |
| 52 | radiant heater |

1. A method for producing a rechargeable battery comprising at least one lithium-ion cell in which a negative electrode, a positive electrode, and a solid electrolyte are arranged, comprising:
mixing an electrolyte suspension comprising an electrolyte material for creating the solid electrolyte;
creating a green sheet using the electrolyte suspension; and
applying a protective layer onto the green sheet, which comprises a base element for a lithium alloy.

2. The method according to claim 1, further comprising sintering the green sheet together with the protective layer so that the solid electrolyte is formed from the green sheet.

3. The method according to claim 1, further comprising forming the negative electrode during a formation process in that lithium is conducted from the solid electrolyte using an electrical voltage to the protective layer, so that a lithium alloy is created from the base element and the lithium.

4. The method according to claim 1, further comprising
mixing a base element suspension comprising the base element; and
applying the base element suspension onto the green sheet for creating the protective layer.

5. The method according to claim 1, wherein the base element and the electrolyte material are configured such that the base element has a melting point that is higher than the sintering temperature of the electrolyte material.

6. The method according to claim 1, further comprising sintering the green sheet together with the protective layer, and applying a current collector onto the protective layer prior to sintering.

7. The method according to claim 6, wherein the current collector is formed by a metal film, and further comprising applying the metal film while dispensing with an additional binder.

8. The method according to claim 1, further comprising
sintering the green sheet together with the protective layer so that the solid electrolyte is formed from the green sheet;
mixing an electrode suspension, comprising an electrode material, to create the positive electrode; and
applying an electrode layer onto the solid electrolyte with the electrode suspension.

9. A rechargeable battery, comprising:
at least one lithium-ion cell, comprising a negative electrode, a positive electrode and a solid electrolyte, wherein the solid electrolyte comprises a mixed electrolyte suspension comprising an electrolyte material;
a green sheet configured from the electrolyte suspension; and
a lithium alloy comprising a base element configured from a protective layer being applied to the green sheet.

10. The rechargeable battery according to claim 9, wherein the green sheet is sintered together with the protective layer so that the solid electrolyte is formed from the green sheet.

11. The rechargeable battery according to claim 9, wherein the negative electrode is configured such that lithium is conducted from the solid electrolyte using an electrical voltage to the protective layer, so that a lithium alloy is created from the base element and the lithium.

12. The rechargeable battery according to claim 9, wherein the protective layer comprises a mixed base element suspension comprising the base element, wherein the mixed base element suspension is applied onto the green sheet.

13. The rechargeable battery according to claim 9, wherein the base element and the electrolyte material are configured such that the base element has a melting point that is higher than the sintering temperature of the electrolyte material.

14. The rechargeable battery according to claim 9, wherein the green sheet is sintered together with the protective layer, and wherein a current collector is applied onto the protective layer prior to sintering.

15. The rechargeable battery according to claim 14, wherein the current collector is formed by a metal film, and the metal film is applied while dispensing with an additional binder.

16. The rechargeable battery according to claim 9,
wherein the solid electrolyte is formed from the green sheet by sintering the green sheet together with the protective layer,
wherein the positive electrode is formed from a mixed electrode suspension comprising an electrode material, and
wherein an electrode layer is applied onto the solid electrolyte with the electrode suspension.

17. A method for producing a rechargeable battery comprising at least one lithium-ion cell in which a negative electrode, a positive electrode, and a solid electrolyte are arranged, comprising:
mixing an electrolyte suspension comprising an electrolyte material for creating the solid electrolyte;
creating a green sheet using the electrolyte suspension; and
applying a protective layer onto the green sheet, which comprises a base element for a lithium alloy;
sintering the green sheet together with the protective layer so that the solid electrolyte is formed from the green sheet.

18. The method according to claim 17, further comprising forming the negative electrode during a formation process in that lithium is conducted from the solid electrolyte using an electrical voltage to the protective layer, so that a lithium alloy is created from the base element and the lithium.

19. The method according to claim 17, further comprising
mixing a base element suspension comprising the base element; and
applying the base element suspension onto the green sheet for creating the protective layer.

20. The method according to claim 17, further comprising sintering the green sheet together with the protective layer, and applying a current collector onto the protective layer prior to sintering.
